(19) United States
(12) Patent Application Publication
(10) Pub. No.: US 2010/0269831 A1
(43) Pub. Date: Oct. 28, 2010

(54) Breathing Mask

(76) Inventor: Torben Skov, Pliezhausen (DE)

Correspondence Address: CHARLES H. SCHWARTZ;MOLDEX-METRIC, INC, 10111 W. JEFFERSON BOULEVARD, CULVER CITY, CA, 90232, US

(21) Appl. No.: 12/661,833

(22) Filed: Mar. 25, 2010

(30) Foreign Application Priority Data
Apr. 24, 2009 (DE) EPA 09 005 783.7

(51) Int. Cl. A62B 18/10; A62B 23/02

(52) U.S. Cl. 128/206.15; 128/206.22

(57) ABSTRACT

A breathing mask (1) with a mask body (2) comprising a filter material and with an exhalation valve (5) penetrating the mask body (2) is described here. In order to protect such a breathing mask against the collection of condensate, the invention suggests that a condensing surface on the exhalation valve (5) is connected with a condensate receiving area (11) in the mask body (2).

### BACKGROUND OF THE INVENTION

The invention is related to a breathing mask (or face mask) with a mask body comprising a filter material, and with an exhalation valve penetrating the mask body.

Such a breathing mask is known e.g. from EP 0 267 428. The conventional breathing mask comprises an exhalation valve formed in a unitary manner from a rubber or a rubber-like plastic material, the exhalation mask being buttoned into an opening in the mask body. The exhalation valve comprises an exhalation opening arranged on a lip valve, which is arranged adjacent to the buttoning position on the mask body towards the outside. In the normal, closed state, the two walls of the lip valve are in planar contact with each other in the area of the outlet opening, such that no unfiltered air may ingress during inhalation. During exhalation, the exhalation pressure opens the lip valve and, hence, the exhalation opening, such that the air may escape. However, this leads to the generation of condensate condensing on the inside of the lip valve, which possibly remains at this position and impairs the tightness of the exhalation valve, or drips from the exhalation valve and e.g. contaminates the working surfaces which are being processed by the person wearing the mask. The problem of the generation of condensate has also been observed with other exhalation valves.

It is the object of the invention to provide a breathing mask with improved protection against dripping condensate.

This object is solved by the features of claim 1.

By means of the structure of the present invention, deposited condensate is guided into the mask body, such that it may neither drip nor impair the sealing function of the exhalation valve.

Preferable further improvements of the invention are referred to in the dependent claims.

The arrangement of the condensate receiving area and the condensing surface should be harmonized in such a way with the respective construction of the breathing valve, that the condensing surface is substantially aligned with the mask body, such that the condensate is guided back into the mask body, preferably by the effect of gravity. If the exhalation valve comprises a covering, this should preferably overlie the mask body and should preferably have a guiding surface for guiding the condensate.

For example, an area of the filter material which is permeable for diffusion in the direction of the condensing surface may be provided as the receiving area, or a hollow area of a covering layer of the filter material open in the direction of the condensing surface may be provided as the receiving area.

Preferably, the receiving area is connected with a distribution area for the condensate in the mask body, such that the received condensate may be distributed within the mask body. This increases not only the tendency for evaporation, but also the receiving capacity.

In order to form the open or diffusion-permeable areas, it is important that the area of the mask body around the exhalation valve is not compressed by welding or pressing. A preferred possibility for avoiding this compression is to accommodate the exhalation valve in a valve holder which is either formed as a separate housing and preferably mounted by a friction connection in the corresponding opening in the mask body itself, but may also be connected by a positive fit, form fit, or the like. However, the valve holder may also be directly formed on the mask body.

Should the housing form a condensing surface by itself, it is preferably inclined from the inside to the outside and in a flow connection with the condensate receiving area, such that also the condensate generated here may be guided into the mask body.

Preferred embodiments of the invention will now be described with reference to the drawings, in which:

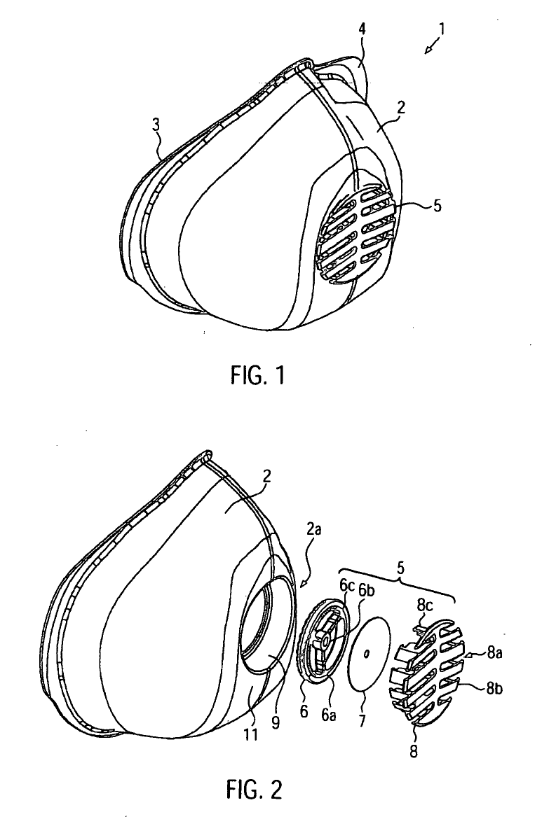

FIG. 1. is a perspective view of a breathing mask, according to the invention;

FIG. 2 is an exploded view of the breathing mask shown in FIG. 1;

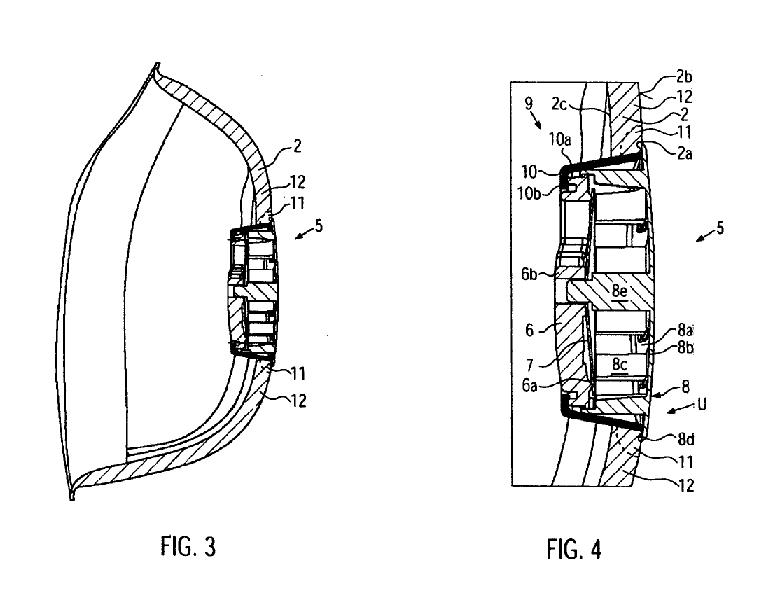

FIG. 3 is a vertical section through the breathing mask shown in FIG. 1;

FIG. 4 is an enlarged view of the valve area of the breathing mask in a vertical section;

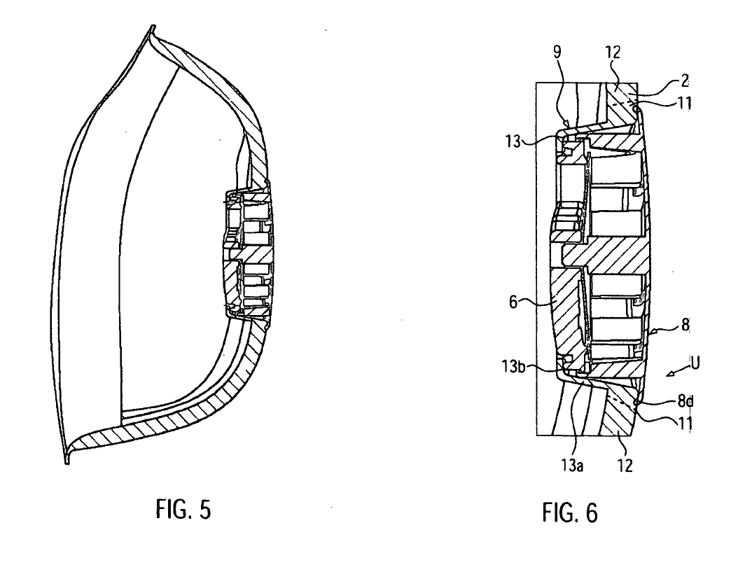

FIG. 5 is a vertical section through a second embodiment of a breathing mask; and

FIG. 6 is an enlarged view of the valve area of the breathing mask shown in FIG. 5.

Throughout the drawings, the same components are labelled with the same reference numerals.

FIG. 1 shows a first embodiment of a breathing or face mask 1 according to the invention.

### DETAILED DESCRIPTION OF THE DRAWINGS

The breathing mask 1 is a so-called half-mask, i.e. it is carried over mouth and nose of the person wearing the mask, but does not cover the eyes. The breathing mask 1 comprises a mask body 2 which is stiff on demolding in such a way that it does not collapse during inhalation. The mask body 2 is made from conventional material, i.e. the mask may e.g. be completely formed from a filter material, or it may comprise a filter material between two support layers or a filter material with a cover layer. The filter material, as well as the further layers of the mask body 2, must be air-permeable, i.e. open porous. The mask body 2 comprises the usual face sealing 3, which contacts the face of the person wearing the mask in a flexible sealing manner when the mask body 2 is mounted on the head of the person by means of a band 4.

The exhalation mask 1 of the present invention is further provided with an exhalation valve 5 which, during exhalation, has a lower passage resistance than the wall of the mask body 2, such that exhalation is facilitated.

As shown in FIG. 2, the exhalation valve 5 of the present embodiment comprises a valve seat 6, a flap 7, and a covering 8. The valve seat 6, the flap 7 and the covering 8 are substantially circular. The valve seat 6 comprises a sealing surface 6a which preferably extends in an angular manner. In the inside of this ring, the flap 4 is mounted (preferably buttoned) via a fastener 6b, which is connected with the angular sealing surface 6a by means of webs 6c. The flap 7 is made from a flexible material which is conventional for such exhalation valves, for example rubber or a rubber-like plastic material, which is adapted to detach from the sealing surface 6a in response to a flow from the inside of the mask body 2, in order to open an exhalation flow path. The covering 8 is preferably made from a plastic material and extends over the complete area which is taken by the valve seat 6 and the flap 7. The covering 8 comprises exhalation openings 8a of a suitable form, which are mutually separated by impermeable areas of material 8b. By means of distance pieces 8c, the covering 8 is held in a distance from the flap 7, in order not to impair movement of the flap 7 during exhalation.

The exhalation valve 5 is accommodated in a valve reception 9 sitting in an opening 2a of the mask body 2. As shown in FIGS. 3 and 4, the valve reception 9 comprises in one embodiment a pot-like housing 10 from plastic material or the like which has a cross section diverging from the inside to the outside. The pot-like housing 6 covers the natural cut edges of the material of the mask body 2 in the area of the opening 2a, is aligned substantially with the outside surface 2b of the mask body 2, and projects over the interior surface 2c of the mask body 2 into the interior of the mask body. The bottom of the pot-like housing 10 is provided by the valve part 6, into which center hub 6b, a pin wrench 8e of the covering 8 is inserted with the flap 7 arranged in between, in order to mount the flap 7 on the valve part 6b. The housing 10 comprises a substantially conical wall 10a provided on the small diameter side with a radial mounting flange 10b, on which the valve part 6 is mounted.

The covering 8 is provided on its circumferential edges with an edge 8d anchored to the inside, which overlaps the wall 10a on the outside of the mask body 2 and is pressed into the material of the mask body 2. In this position, there is an area 11, in which the material of the mask body 2 is adapted to receive condensate. This means that this area is not compressed by welding, nor by mechanical pressure or the like in such a way that no or hardly any cavities would remain in the material of the mask body 2. The area 11 may have the porosity or capillarity of the material of the mask body, but may also be formed in an especially porous way and/or with an especially high absorbtivity. The shape of the receiving cavities for the condensate may be made depending on the material properties of the layer of material of the mask body 2 in this area. For example, relatively large cavities may be formed in a net-like covering layer, while smaller cavities, while larger in number, may be provided in areas where the filter material reaches towards the outside 2b of the mask body 2. The condensate receiving area 11 may be followed by a distribution area 12, which in principle may cover the complete mask body, and which distributes the condensate over the complete, large area of the mask body 2, such that the condensate may more easily evaporate without impairing comfort.

The humidity comprised in the exhaled air condenses on all parts of the exhalation valve 5, but mainly on the covering 8, and, due to gravity, flows down on the covering 8 and also on the pot-like wall 10a, here due to the inclination of the wall 10a from inside to outside, towards a lower position U, where the condensate is guided into the area 11 by means of the angled edge 8d acting as a guide surface. Even after putting the mask down, or when the person wearing the mask holds his or her head inclined, the condensate may be collected around the covering 8 and be guided into the mask body 2.

FIGS. 5 and 6 show another embodiment of the invention, which differs from the embodiments of FIGS. 3 and 4 only by a differing construction of the valve reception 9. In this embodiment, the valve reception 9 is also formed by a pot-like structure. However, this structure is now formed by a part 13 of the material of the mask body 2 being drawn into the interior of the breathing mask. In a suitable manner, the drawn pot-like structure 13, in particular the conical wall 13a, may also comprise cavities and/or capillaries through which the condensate collected here or being guided here reaches the area 11. In this embodiment, the area 11 comprises the area of the material of the mask body 2, extending around the opening 2a as well as the area of the drawn pot-like structure 13. This receiving area 11 is followed by the distribution area 12, which again may extend over the entire surface of the mask body 2.

In order to alter the described and shown embodiments, the condensate receiving area of the present invention may also be used by exhalation valves or breathing masks constructed in a different way. Depending on the construction of the exhalation valve, different exposed surfaces will arise, on which condensate condenses in larger amounts. According to the invention, these surfaces are then either directly or by means of guide surfaces connected in a condensate receiving manner with the material of the mask body.

We claim:

1. A breathing mask with a mask body comprising a filter material, and with an exhalation valve penetrating the mask body, characterized in that a condensing surface on the exhalation valve is connected with a condensate receiving area in the mask body.

2. The breathing mask according to claim 1, characterized in that the condensing surface is substantially aligned with the mask body.

3. The breathing mask according to claim 1, characterized in that the condensing surface comprises a guide surface directed to the receiving area.

4. The breathing mask according to claim 1, characterized in that the condensing surface is provided on a covering of the exhalation valve which overlies the mask body.

5. The breathing mask according to claim 1, characterized in that the receiving area comprises an area of the material of the mask body which is permeable for diffusion in the direction of the condensing surface.

6. The breathing mask according to claims 1, characterized in that the receiving area comprises a cavity area of a covering layer of the mask body which is open in the direction of the condensing surface.

7. The breathing mask according to claim 1, characterized in that the receiving area is in connection with a condensate distribution area on the mask body.

8. The breathing mask according to claim 1, characterized in that the exhalation valve is accommodated in a valve reception which projects over an interior surface of the mask body into the interior of the mask body.

9. The breathing mask according to claim 8, characterized in that the valve reception comprises a housing which is in a friction fit in an opening in the mask body.

10. The breathing mask according to claim 8, characterized in that the valve reception comprises a deep-drawn structure from a material of the mask body extending into an opening on the mask body.

11. The breathing mask according to claim 8, characterized in that the valve reception comprises a boundary inclined from the inside to the outside, which is in a flow connection with the condensate receiving area.
